(19) United States
(12) Patent Application Publication
(10) Pub. No.: US 2010/0310261 A1
(43) Pub. Date: Dec. 9, 2010

(54) IMAGE FORMING APPARATUS AND SHEET CONVEYING METHOD FOR THE IMAGE FORMING APPARATUS

(75) Inventor: TOSHIHIRO MATSUSHIMA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/791,538

(22) Filed: Jun. 1, 2010

Related U.S. Application Data
(60) Provisional application No. 61/183,634, filed on Jun. 3, 2009.

(51) Int. Cl. G03G 15/00

(52) U.S. Cl. 399/16

(57) ABSTRACT

In an image forming apparatus and a sheet conveying method for the image forming apparatus, the image forming apparatus including: a sensor arranged halfway in a sheet conveying path and configured to output a signal corresponding to thickness of a sheet; a sheet feeder configured to extract sheets one by one; and a storage configured to store weighting and a threshold for each type and store an outlet corresponding to the sheet feeing unit, when a difference of thickness that is an absolute value of a difference between weighting of set thickness and weighting of detected thickness is equal to or larger than a threshold, the image forming apparatus discharges the sheet to the outlet of the sheet corresponding to the sheet feeder without causing the sheet to pass through a transfer device.

### CROSS-REFERENCE TO RELATED APPLICATIONS

This application is based upon and claims the benefit of priority from the prior the U.S.A. Patent Application No. 61/183,634, filed on Jun. 3, 2009, and the entire contents of which are incorporated herein by reference.

### FIELD

The present embodiment relates to an image forming apparatus configured to collect, when an unexpected sheet is conveyed, the sheet without deteriorating the sheet and a sheet conveying method for the image forming apparatus.

### BACKGROUND

Image forming apparatuses such as a copying machine, a MFP (Multifunction Peripheral), and a printer can form images on sheets having different thicknesses with methods corresponding to the thicknesses.

However, when a sheet having unexpected thickness is conveyed, in some case, an image is deteriorated or a jam occurs.

There is known an image forming apparatus configured to determine, when an unexpected sheet is conveyed, that a jam occurs and stop the conveyance.

However, this image forming apparatus has a problem in that, when the sheet stopped to be conveyed is removed, the sheet is scratched and cannot be reused.

Concerning this point, there is proposed an image forming apparatus including a sensor for detecting the thickness of a sheet and configured to discharge, when a sheet having unexpected thickness is conveyed, the sheet.

### DESCRIPTION OF THE DRAWINGS

FIG. 1 is a diagram of the configuration of an image forming apparatus;

FIG. 2 is an external perspective view of a sensor unit;

FIG. 3 is a perspective view of a sensor;

FIG. 4 is a schematic diagram of the configuration of the image forming apparatus;

FIG. 5 is a diagram of the structure of a threshold table;

FIG. 6 is a diagram of the structure of an outlet table; and

FIG. 7 is a flowchart for explaining sheet discharging operation of the image forming apparatus.

### DETAILED DESCRIPTION

Throughout this description, the embodiments and examples shown should be considered as exemplars, rather than limitations on the apparatus and methods of the present embodiment.

An image forming apparatus and a sheet conveying method for the image forming apparatus according to an embodiment of the present invention are explained in detail below with reference to the accompanying drawings. The image forming apparatus is, for example, a copying machine, a MFP (Multifunction Peripheral), or a printer.

An image forming apparatus 1 according to this embodiment includes: a sheet feeder configured to feed sheets one by one; a sensor configured to detect a type of the conveyed sheet as a first type; an image carrier configured to bear an electrostatic latent image; a developer configured to supply a toner to the electrostatic latent image; a transfer device configured to transfer a toner image onto the sheet; a fuser configured to fix the toner image on the sheet; a storage configured to store a second type that is a type of the sheet on which an image is formed; and a processor configured to discharge, when the first type and the second type are different, the sheet without causing the sheet to pass through the transfer device.

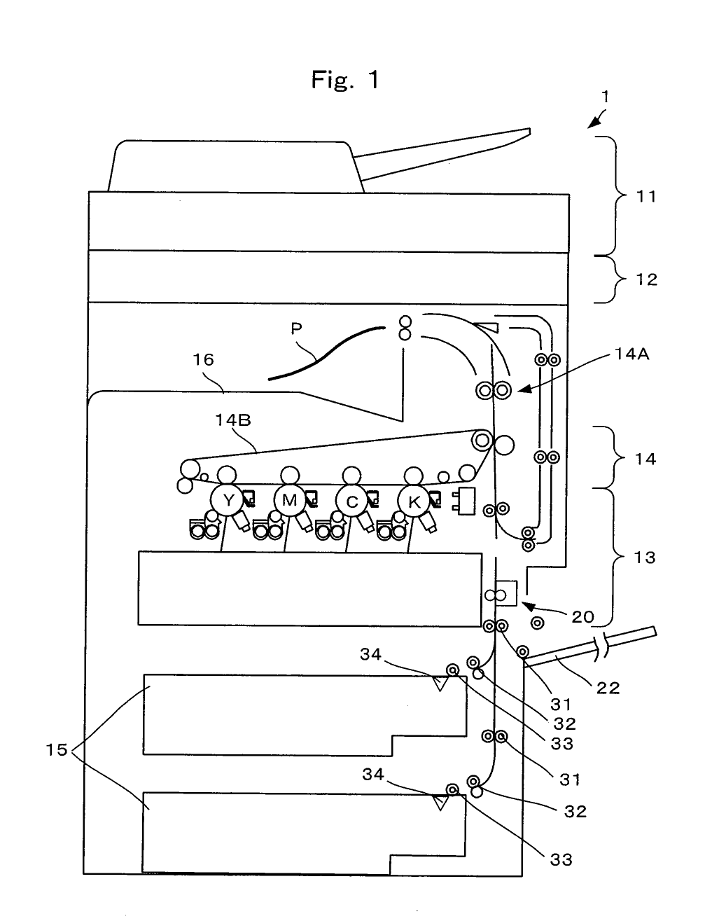

FIG. 1 is a diagram of the configuration of the image forming apparatus 1 according to this embodiment. As shown in FIG. 1, the image forming apparatus 1 includes an auto document feeder 11, a scanner 12, an image forming unit 13, a transfer unit 14, a sheet conveying mechanism, a sheet feeder 15, and a manual feed tray 22.

The image forming apparatus 1 includes the auto document feeder 11 openably and closably provided in an upper part of a main body of the image forming apparatus 1. The auto document feeder 11 includes a document conveying mechanism configured to extract original documents from a paper feeding tray one by one and convey the original document to a paper discharge tray.

The auto document feeder 11 conveys, with the document conveying mechanism, the original documents to a document reading unit of the scanner 12 one by one. A user can open the auto document feeder 11 and place an original document on a document table of the scanner 12.

The scanner 12 includes a carriage including an exposure lamp configured to expose an original document to light and a first reflection mirror, plural second reflection mirrors locked by a main body frame of the image forming apparatus 1, a lens block, and a CCD (Charge Coupled Device) of an image reading sensor.

The carriage stands still in the document reading unit or reciprocatingly moves below the document table and causes the first reflection mirror to reflect the light of the exposure lamp reflected by the original document. The plural second reflection mirrors reflect the reflected light of the first reflection mirror to the lens block. The lens block magnifies the reflected light and outputs the reflected light to a CCD. The CCD converts the incident light into an electric signal and outputs the electric signal to the image forming unit 13 as an image signal.

The image forming unit 13 includes, for each of yellow Y, magenta M, cyan C, and black K, a laser irradiating unit, a photoconductive drum as an image carrier, and a developer.

The laser irradiating unit irradiates a laser beam on the photoconductive drum on the basis of the image signal and forms an electrostatic latent image on the photoconductive drum. The developer supplies a toner to the photoconductive drum and forms a toner image from the electrostatic latent image.

The sheet feeder 15 extracts sheets from paper feeding cassettes one by one and passes the sheet to the sheet conveying mechanism. The sheet conveying mechanism conveys the sheet to the transfer unit 14. The manual feed tray 22 passes sheets to the sheet conveying mechanism one by one. The sheet feeder 15 and the manual feed tray 22 are collectively referred to as sheet feeder.

The transfer unit 14 includes a transfer belt 14B, a transfer roller as a transfer device, and a fuser 14A. The transfer belt 14B as an image bearing member receives the transfer of the toner image on the photoconductive drum and bears the toner image. The transfer roller applies voltage or pressure to the toner image on the transfer belt 14B and transfers the toner image to a sheet conveyed thereto. The fuser 14A heats and presses the toner image and fixes the toner image on the sheet.

The image forming apparatus 1 includes, halfway in a sheet conveying path of the sheet conveying mechanism, a sensor unit 20 configured to detect the thickness of a sheet. The image forming apparatus 1 includes the sensor 20 further upstream in a sheet conveying direction than the fuser 14A of the transfer unit 14.

The sheet conveying mechanism includes, upstream in the sheet conveying direction of the sensor unit 20, plural conveying rollers 31 and 32 configured to convey a sheet. The sheet feeder 15 includes pickup rollers 33 configured to extract sheets from the paper feeding cassettes one by one. The pickup rollers 33 descend during paper feeding.

The image forming apparatus 1 stacks a sheet P discharged from a paper discharge port on a paper discharge tray 16.

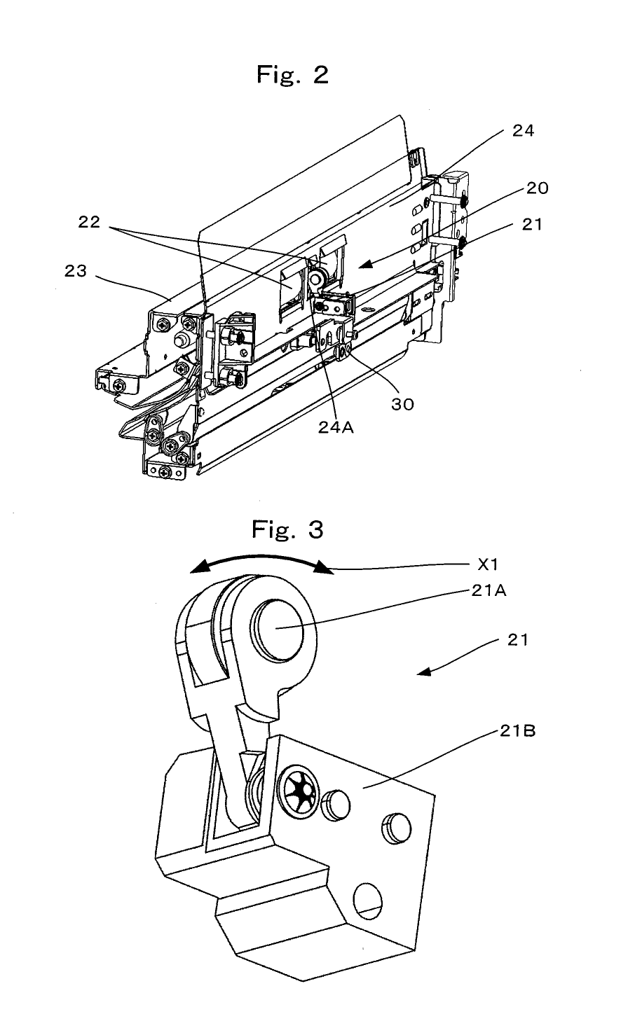

FIG. 2 is an external perspective view of the sensor unit 20. As shown in FIG. 2, the sensor unit 20 includes a sensor 21, a pair of sheet conveying driving rollers 22, and a pair of sheet conveying driven rollers configured to rotate following the sheet conveying driving rollers 22.

The image forming apparatus 1 includes a first sheet guide 23 and a second sheet guide 24. The image forming apparatus 1 conveys a sheet through a space between the first sheet guide 23 and the second sheet guide 24. The image forming apparatus 1 has, in the second sheet guide 24, an opening 24A for allowing a roller 21A of the sensor 21 to come into contact with the conveyed sheet.

The sensor 21 is attached to the second sheet guide 24 via an anti-vibration damper 30.

FIG. 3 is a perspective view of the sensor 21. As shown in FIG. 3, the sensor 21 includes the roller 21A and a sensor body 21B. The roller 21A includes a roller at one end thereof. The other end of the roller 21A is attached to the sensor body unit 21B to be rotatable in an arrow X1 direction.

The sensor 21 detects the thickness of a sheet with, for example, a magnetic sensor. The sensor 21 has, in the base of the roller 21A, a permanent magnet that is displaced according to the rotation of the roller 21A. The magnetic sensor of the sensor body 21B detects a change in magnetic force.

Electric resistance of the magnetic sensor changes according to the magnetic force. The image forming apparatus 1 detects the change in the electric resistance to thereby detect the thickness of the sheet.

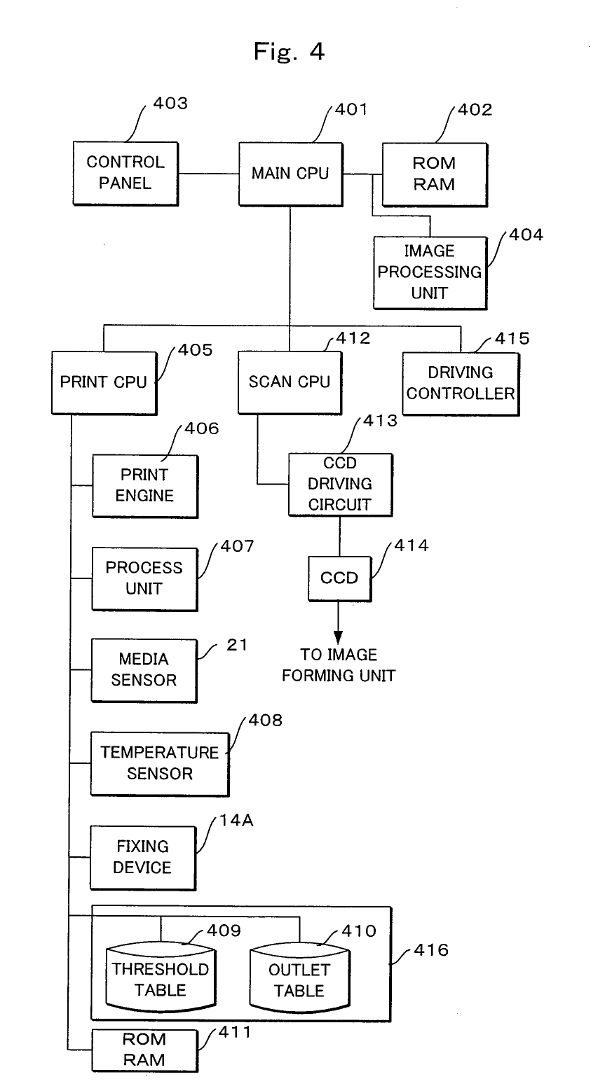

FIG. 4 is a schematic diagram of the configuration of the image forming apparatus 1. As shown in FIG. 4, the image forming apparatus 1 includes a main CPU 401 that is a processor configured to collectively control the entire image forming apparatus 1, a control panel 403 that is a display device connected to the main CPU 401, ROM and RAM 402 as storage devices, and an image processing unit 404 configured to perform image processing.

The main CPU 401 is connected to a print CPU 405 configured to control respective units of an image forming system, a scan CPU 412 configured to control respective units of an image reading system, and a driving controller 415 configured to control a driving unit.

The print CPU 405 controls a print engine 406 configured to form an electrostatic latent image on the photoconductive drum and a process unit 407 configured to form a toner image.

The print CPU 405 is further connected to the sensor 21, the fuser 14A, a temperature sensor 408 configured to detect the temperature of the fuser 14A, ROM and RAM 411 as storage devices, a threshold table 409 in which weighting and a threshold are stored for each sheet type, and an outlet table 410 in which an outlet of a sheet corresponding to a conveyance source of the sheet is stored.

The image forming apparatus 1 includes a storage 416 that is a storage device such as a nonvolatile memory, a hard disk drive, or a RAM. The storage 416 stores the threshold table 409 and the outlet table 410.

The print CPU 405 determines the thickness of a sheet according to an output from the sensor 21 and controls heating temperature of the fuser 14A on the basis of the thickness of the sheet and feedback from the temperature sensor 408. The print CPU 405 further controls the print engine 406 and the process unit 407 on the basis of the thickness of the sheet.

The scan CPU 412 controls a CCD driving circuit 413 configured to drive a CCD 414. A signal from the CCD 414 is output to the image forming unit 13.

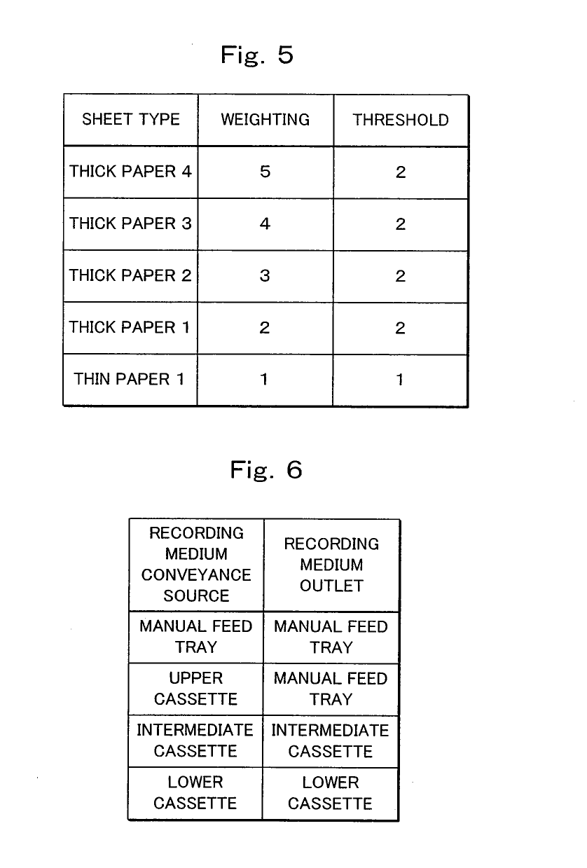

FIG. 5 is a diagram of the structure of the threshold table 409. As shown in FIG. 5, in the threshold table 409, “weighting” and a “threshold” are stored for each “sheet type”.

The “sheet type” indicates a set value designated by the user from the control panel 403 and the detected thickness of a conveyed sheet. In the threshold table 409, for example, “thick paper 4” to “thick paper 1” and “thin paper 1” are stored in the “sheet type”. The “weighting” is a numerical value indicating the thickness of a sheet.

The “threshold” is set as a natural number. The “threshold” is set for each “sheet type”.

The image forming apparatus 1 calculates, using the print CPU 405, a difference of thickness that is an absolute value of a difference between set weighting of a sheet and weighting corresponding to detected thickness of the sheet.

The image forming apparatus 1 compares a threshold corresponding to a set sheet type and the difference of thickness and discharges, when the difference of thickness is equal to or larger than the threshold, the sheet to a sheet outlet without causing the sheet to pass through the fuser 14A. Specifically, when the set type of the sheet and a detected type of the sheet are different, the image forming apparatus 1 discharges the sheet without causing the sheet to pass through the fuser 14A and the transfer device.

The image forming apparatus 1 reversely rotates the sheet conveying mechanism and discharges the sheet to the sheet outlet. The image forming apparatus 1 may have a path different from a path during image formation leading to the sheet outlet.

Specifically, the image forming apparatus 1 stops the conveying rollers 31 and 32 at a timing when the image forming apparatus 1 detects that the set type of the sheet, i.e., the type of the sheet stored by the storage 416 and the detected type of the sheet are different. At the same time, the image forming apparatus 1 lifts the pickup rollers 33. The image forming apparatus 1 reversely rotates the conveying rollers 31 and 32. Finally, after paper feeding sensor 34 of the paper feeding cassettes are turned off, the image forming apparatus 1 stops the conveying rollers 31 and 32 and lowers the pickup rollers 33.

For example, when the set sheet type is “thick paper 4” and the conveyed sheet is “thick paper 3”, |5−4|=1<2. Therefore, the image forming apparatus 1 performs image formation without discharging the sheet.

For example, when the set sheet type is “thick paper 4” and the conveyed sheet is “thick paper 1”, |5−4|=1<2. Therefore, the image forming apparatus 1 discharges the sheet to the sheet outlet without causing the sheet to pass through the fuser 14A.

FIG. 6 is a diagram of the structure of the outlet table 410. As shown in FIG. 6, in the outlet table 410, a “sheet conveyance source” indicating a place where a sheet is stored and a “sheet outlet” that is an outlet of the sheet corresponding to the “sheet conveyance source” are stored.

Examples of data of the “sheet conveyance source” include a “manual feed tray” and an “upper cassette. Examples of data of the “sheet outlet” include the “manual feed tray” and an “intermediate cassette”.

A place to which a sheet not included in the setting is discharged can be freely set according to selection by the user. The place can also be set such that sheets are discharged to some one place, for example, the “manual feed tray” irrespectively of a place of the “sheet conveyance source”. The place can also be set such that sheets are respectively conveyed to sheet conveyance sources.

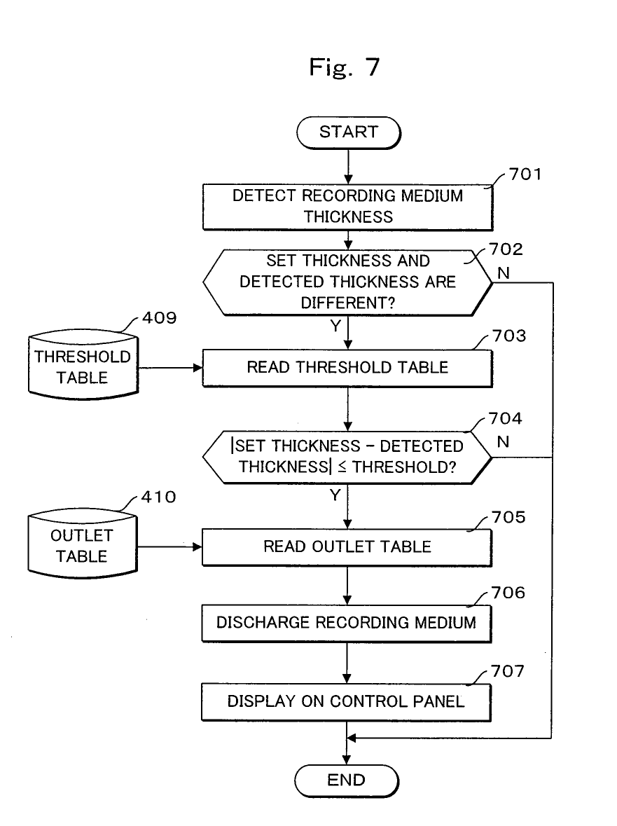

FIG. 7 is a flowchart for explaining sheet discharging operation of the image forming apparatus 1. As shown in FIG. 7, in Act 701, the image forming apparatus 1 detects the thickness of a sheet, i.e., a sheet type on the basis of an output of the sensor 21.

In Act 702, the image forming apparatus 1 determines whether the detected thickness as the detected sheet type is different from set thickness as a sheet type set from the control panel 403. If the detected thickness and the set thickness are different, the image forming apparatus 1 proceeds to Act 703. If the detected thickness and the set thickness are the same, the image forming apparatus 1 ends the processing.

In Act 703, the image forming apparatus 1 reads the threshold table 409. Specifically, the image forming apparatus 1 reads, from the threshold table 409, weighting of the set sheet type, weighting of the detected sheet type, and a threshold corresponding to the set sheet type.

In Act 704, the image forming apparatus 1 determines whether a difference of thickness that is an absolute value of a difference between the weighting of the set sheet type and the weighting of the detected sheet type is equal to or larger than the threshold. If the difference of thickness is equal to or larger than the threshold, the image forming apparatus 1 proceeds to Act 705. If the difference of thickness is smaller than the threshold, the image forming apparatus 1 ends the processing.

In Act 705, the image forming apparatus 1 reads a sheet outlet corresponding to a sheet conveyance source from the outlet table 410.

In Act 706, the image forming apparatus 1 discharges the sheet to the read sheet outlet. In Act 707, the image forming apparatus 1 displays, on the control panel 403, indication that the sheet of the type different from the set sheet type is conveyed and indication of the sheet outlet, and ends the processing.

As explained above, in the image forming apparatus 1 and the sheet conveying method for the image forming apparatus 1 according to this embodiment, the image forming apparatus 1 includes the sensor 21 provided in the sheet conveying path and configured to detect the thickness of a sheet, the sheet feeder configured to extract sheets one by one, the threshold table 409 in which weighting and a threshold are stored for each sheet type, and the outlet table 410 in which an outlet of a sheet corresponding to a conveyance source of the sheet is stored. When a difference of thickness that is an absolute value of a difference between weighting of set thickness and weighting of detected thickness is equal to or larger than a threshold, the image forming apparatus 1 discharges the sheet to the outlet of the sheet corresponding to the conveyance source of the sheet without causing the sheet to pass through the fuser 14A and the transfer device. Therefore, there is an effect that, when a sheet of a type different from a set type of the sheet is conveyed, it is possible to collect the sheet without deteriorating or polluting the sheet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An image forming apparatus comprising:
a sheet feeder configured to feed a sheet;
a sensor configured to detect a type of the sheet as a first type;
an image carrier configured to bear an electrostatic latent image;
a developer configured to supply a toner to develop the electrostatic latent image to a toner image;
a transfer device configured to transfer the toner image onto the sheet;
a fuser configured to fix the toner image on the sheet;
a storage configured to store a second type that is a type of the sheet; and
a processor configured to control to discharge the sheet without causing the sheet to pass through the transfer device if the first type and the second type are different from each other.

2. The apparatus according to claim 1 further comprising a plurality of the sheet feeders configured to feed a sheet, wherein
the storage stores outlets respectively corresponding to the sheet feeders, and
the processor discharges the sheet to an outlet corresponding to the sheet feeder among the outlets without causing the sheet to pass through the transfer device if the first type and the second type are different.

3. The apparatus according to claim 1, wherein the processor conveys the sheet to the sheet feeder without causing the sheet to pass through the transfer device.

4. The apparatus according to claim 1 further comprising an interface configured to input the second type in order to cause the storage to store the second type.

5. The apparatus according to claim 1 further comprising a plurality of the sheet feeders, wherein
the processor conveys the sheet to a sheet feeder different from the sheet feeder that feeds the sheet without causing the sheet to pass through the transfer device.

6. The apparatus according to claim 1 further comprising a manual feed tray configured to feed a sheet, wherein
the processor conveys the sheet supplied from a sheet feeing cassette as the sheet feeder to the manual feed tray without causing the sheet to pass through the transfer device if the first type and the second type are different.

7. The apparatus according to claim 1, wherein the processor causes a display device to display indication that a sheet of a type different from the second type is conveyed from the sheet feeder if the first type and the second type are different.

8. The apparatus according to claim 1, wherein the processor discharges the sheet from the outlet without causing the sheet to pass through the transfer device and causes a display device to display the outlet if the second type and the first type are different.

9. The apparatus according to claim 1, wherein
the storage stores weighting and a threshold for each type, and
the processor discharges the sheet without causing the sheet to pass through the transfer device when an absolute value of a difference between the weighting of the type of the sheet on which an image is formed and the weighting of a detected type is equal to or larger than the threshold.

10. The apparatus according to claim 9, wherein the storage stores a threshold set for the each second type.

11. A sheet conveying method for an image forming apparatus, comprising:
a processor
causing a sheet feeder to feed sheets one by one;
detecting a type of the conveyed sheet as a first type with a sensor;
causing a storage to store a second type that is a type of the sheet on which an image is formed;
if the first type and the second type are the same,
causing a transfer device to transfer a toner image onto the sheet; and
causing a fuser to fix the toner image on the sheet, and
if the first type and the second type are different,
discharging the sheet without causing the sheet to pass through the transfer device.

12. The method according to claim 11 further comprising:
the processor
causing the storage to store outlets respectively corresponding to a plurality of the sheet feeders configured to feed sheets one by one; and
discharging, when the first type and the second type are different, the sheet to an outlet corresponding to the sheet feeder among the outlets without causing the sheet to pass through the transfer device.

13. The method according to claim 11 further comprising the processor conveying the sheet to the sheet feeder without causing the sheet to pass through the transfer device.

14. The method according to claim 11 further comprising the processor inputting the second type in order to cause the storage to store the second type with an interface.

15. The method according to claim 11 further comprising the processor conveying the sheet to a sheet feeder different from the sheet feeder that feeds the sheet if causing the sheet to pass through the transfer device.

16. The method according to claim 11 further comprising the processor conveying the sheet supplied from a sheet feeing cassette as the sheet feeder, to a manual feed tray without causing the sheet to pass through the transfer device if the first type and the second type are different.

17. The method according to claim 11 further comprising the processor causing a display device to display indication that a sheet of a type different from the second type is conveyed from the sheet feeder if the first type and the second type are different.

18. The method according to claim 11 further comprising the processor discharging the sheet from the outlet without causing the sheet to pass through the transfer device and causing a display device to display the outlet if the second type and the first type are different.

19. The method according to claim 11 further comprising: the processor
causing the storage to store weighting and a threshold for each type, and
discharging the sheet without causing the sheet to pass through the transfer device when an absolute value of a difference between the weighting of the type of the sheet on which an image is formed and the weighting of a detected type is equal to or larger than the threshold.

20. The method according to claim 19 further comprising the processor causing the storage to store a threshold set for the each second type.
